(19) United States
(12) Patent Application Publication
(10) Pub. No.: US 2026/0097388 A1
(43) Pub. Date: Apr. 9, 2026

(54) METAL ORGANIC FRAMEWORK, GAS ADSORBENT, KNEADED YARN, TEXTILE PRODUCT, AND RESIN COMPOSITE

(71) Applicant: TOAGOSEI CO., LTD., Tokyo (JP)

(72) Inventors: Mayu HANAI HAYAKAWA, Aichi (JP); Yoshinao YAMADA, Aichi (JP)

(73) Assignee: TOAGOSEI CO., LTD., Tokyo (JP)

(21) Appl. No.: 19/143,249

(22) PCT Filed: Dec. 12, 2023
(86) PCT No.: PCT/JP2023/044475

§ 371 Date: Jun. 25, 2025

(30) Foreign Application Priority Data
Dec. 28, 2022 (JP) 2022-212322

(51) Int. Cl. B01J 20/22; B01D 53/02; B01J 20/28

(52) U.S. Cl. CPC B01J 20/226; B01D 53/02; B01J 20/28023; B01J 20/28026; B01D 2253/204; B01D 2257/70

(57) ABSTRACT

The metal organic framework of the present disclosure includes: at least one metal atom selected from the group consisting of Zr, Zn, Al, and Mg; and an organic ligand having at least one group selected from the group consisting of a carboxy group and a carboxylate group. The content of nitrogen atoms is less than 5 mass % with respect to the total mass of the metal organic framework.

### TECHNICAL FIELD

The present disclosure relates to a metal organic framework, a gas adsorbent, a kneaded yarn, a textile product, and a resin composite.

### BACKGROUND ART

The “malodor” refers to an unpleasant odor that can be perceived by humans. Malodor includes those generated by business activities as defined in the Offensive Odor Control Law. Malodor also includes human body odor and daily life odor (for example, odor of dust or the like). It is important to remove these malodors in our life in order to preserve living environment.

Hitherto, gas adsorbents for malodor have been developed using various materials including activated carbon and zeolite. Among them, the metal organic framework (MOF, also referred to as “porous metal complex”) is a material attracting attention for the use as a gas adsorbent in recent years.

The “metal organic framework” is a porous three-dimensional framework formed of a central metal and an organic ligand. The metal organic framework is also called MOF (Metal Organic Framework) and has been extensively studied in recent years. The metal organic framework is characterized by a large specific surface area and freedom of design. The MOF has uniform micropores and has a large specific surface area. Therefore, high adsorption performance can be expected.

Patent Document 1 discloses that MOF is used as a deodorant for daily life odor. Patent Document 2 discloses that MOF is used as a deodorant for malodor. Patent Documents 3 and 4 disclose that MOF is used as an adsorbent for aldehyde gas caused by tobacco or the like.
Patent Document 1: Japanese Patent Application Laid-Open (JP-A) No. 2019-88499
Patent Document 2: WO 2007/035596 A2
Patent Document 3: WO 2015/046417 A1
Patent Document 4: U.S. Pat. No. 9,307,790

### SUMMARY OF INVENTION

### Technical Problem

In recent years, the need for acidic gases including sweat odors has increased, and there is a need for a gas adsorbent that can be kneaded into a resin and a gas adsorbent that can be processed into a fiber.

The metal organic framework is a material that is expected to be used as an adsorbent. However, according to the study of the inventors, it has been found that an MOF having a nitrogen-containing group in its ligand colors a polyester resin.

As a result of intensive studies on the cause of the coloring, it is presumed that the nitrogen-containing group promotes the decomposition of a polyester resin, and the resulting quinone structure shifts the absorption wavelength of the polyester resin to the visible light side, which is the main cause of coloring.

The hydrolysis and coloring of a resin as described above greatly limit the processing use of an adsorbent. Therefore, the resins to which the metal organic framework can be applied have been limited.

An object of the present disclosure is to provide a metal organic framework capable of suppressing deterioration of a polyester resin, and a gas adsorbent containing the metal organic framework.

Another object of the disclosure is to provide a kneaded yarn, a textile product, or a resin composite each using the gas adsorbent.

### Solution to Problem

The solution to problem includes the following embodiments.

<1> A metal organic framework, including:
at least one metal atom selected from the group consisting of Zr, Zn, Al, and Mg; and
an organic ligand having at least one group selected from the group consisting of a carboxy group and a carboxylate group,
wherein a content of nitrogen atoms is less than 5 mass % with respect to a total mass of the metal organic framework.

<2> A gas adsorbent, including:
a metal organic framework including:
   at least one metal atom selected from the group consisting of Zr, Zn, Al, and Mg; and
   an organic ligand having at least one group selected from the group consisting of a carboxy group and a carboxylate group.

<3> The gas adsorbent according to <2>, wherein a content of nitrogen atoms is less than 5 mass % with respect to a total mass of the gas adsorbent.

<4> The gas adsorbent according to <2> or <3>, wherein an adsorption capacity of acetic acid gas is 40 mL/g or more.

<5> The gas adsorbent according to any one of <2> to <4>, wherein the metal atom in the metal organic framework is Zr, and the organic ligand is a polycarboxylic acid or an anion of the polycarboxylic acid.

<6> The gas adsorbent according to any one of <2> to <5>, which is used for adsorbing a malodorous gas.

<7> The gas adsorbent according to <6>, wherein the malodorous gas is an acidic gas.

<8> The gas adsorbent according to any one of <2> to <7>, wherein the organic ligand is a polycarboxylic acid having a benzene skeleton or an anion of the polycarboxylic acid.

<9> The gas adsorbent according to any one of <2> to <8>, wherein a reduction rate represented by the following Formula (1) is 50% or less:

$$Reduction rate = 100 \times \{ ( weight average molecular weight of heated product of polyester resin alone ) - ( weight average molecular weight of heated product of mixture ) / ( weight average molecular weight of heated product of the polyester resin alone ) \} \qquad Formula ( 1 )$$

wherein, the heated product of the mixture represents a product obtained by heating a mixture of 80 parts by mass of the polyester resin and 20 parts by mass of the gas adsorbent at 280° C. for 1 hour, and
in Formula (1), the heated product of the polyester resin alone represents a product obtained by heating the polyester resin alone at 280° C. for 1 hour.

<10> A kneaded yarn, including the gas adsorbent according to any one of <2> to <9>.

<11> A textile product, including the gas adsorbent according to any one of <2> to <9>.

<12> A resin composite, including the gas adsorbent according to any one of <2> to <9>.

### Advantageous Effects of Invention

According to the disclosure, a metal organic framework capable of suppressing deterioration of a polyester resin and a gas adsorbent containing the metal organic framework can be provided.

According to the disclosure, a kneaded yarn, a textile product, or a resin composite each using the gas adsorbent can be provided.

### BRIEF DESCRIPTION OF DRAWINGS

FIG. 1 is a powder X-ray crystal structure analysis (PXRD) spectrum of a metal organic framework produced in Example 1.

FIG. 2 is a powder X-ray crystal structure analysis (PXRD) spectrum of a metal organic framework produced in Example 2.

FIG. 3 is a powder X-ray crystal structure analysis (PXRD) spectrum of a metal organic framework produced in Comparative Example 1.

### DESCRIPTION OF EMBODIMENTS

The description of the requirements described below may be made based on representative embodiments of the disclosure, but the disclosure is not limited to such embodiments. In the present specification, “to” is used to mean that the numerical values described before and after the “to” are included as the lower limit value and the upper limit value.

In a numerical range described in stages in the specification, the upper limit value or the lower limit value described in one numerical range may be replaced with an upper limit value or a lower limit value in another numerical range described in stages. In a numerical range described in the specification, the upper limit value or the lower limit value of the numerical range may be replaced with a value shown in Examples.

In the disclosure, when the composition contains a plurality of substances that correspond to each component, the amount of each component in the composition means the total amount of the plurality of substances contained in the composition unless otherwise specified.

In the disclosure, the term “step” is not limited to an independent step. A step that cannot be clearly distinguished from other steps but achieves the intended action of the step is included in the term.

In the disclosure, “mass %” and “weight %” are synonymous, and “parts by mass” and “parts by weight” are synonymous.

In the disclosure, any combination of two or more preferred embodiments is a more preferred embodiment.

Hereinafter, the contents of the disclosure will be described in detail.

### (Gas Adsorbent)

The gas adsorbent of the disclosure includes a metal organic framework. The metal organic framework includes: at least one metal atom selected from the group consisting of Zr, Zn, Al, and Mg; and an organic ligand having at least one group selected from the group consisting of a carboxy group and a carboxylate group.

The gas adsorbent of the disclosure can be suitably used as an acidic gas adsorbent.

The gas adsorbent of the disclosure can be suitably used as a gas adsorbent to be kneaded in a resin, and can be more suitably used as a gas adsorbent to be kneaded in a polyester resin.

The gas adsorbent of an embodiment of the disclosure can be used as a deodorant in various applications. The gas adsorbent of an embodiment of the disclosure is blended in a fiber, a resin, a liquid (for example, water, an organic solvent, or the like), or the like, and can be used as a raw material for producing a deodorant product.

Examples of the use of the deodorant product include a deodorant processing solution, a deodorant fiber, a deodorant resin composition, a deodorant cloth, and a deodorant filter medium.

As a result of intensive studies, the present inventors found that the configurations make it possible to provide a gas adsorbent containing a metal organic framework capable of suppressing deterioration of a polyester resin, specifically, as follows.

The inventors detailly studied and found that a metal organic framework combining: at least one metal atom selected from the group consisting of Zr. Zn, Al, and Mg; and an organic ligand having at least one group selected from the group consisting of a carboxy group and a carboxylate group can suppress deterioration of a polyester resin. In addition, the inventors have found that the metal organic framework is excellent in gas adsorption performance. In the combination, the metal organic framework has pores of appropriate size and excellent uniformity, and has a large specific surface area. Therefore, it is presumed that the gas adsorption material of the disclosure is excellent in gas adsorption performance.

The metal organic framework used in the gas adsorbent of the disclosure has high adsorption performance for acetic acid gas contained in human body odors (for example, sweat odor and the like) and the like. The metal organic framework is a white powder.

The gas adsorbent of the disclosure, having a reduced nitrogen content (such as a compound having a nitrogen atom) in the gas adsorbent, can suppress decomposition of a resin during heating and mixing with an ester-based resin and during molding.

Furthermore, the gas adsorbent of the disclosure can also suppress coloring of a resin. Therefore, the gas adsorbent of the disclosure can also be applied to a resin that has not been used due to hydrolysis or coloring (for example, polyester resin or the like). As a result, the gas adsorbent has an extremely wide processing application.

The gas adsorbent is preferably used for adsorbing a malodorous gas. In the disclosure, the “malodorous gas” refers to a gas that a person feels uncomfortable. The “a gas that a person feels uncomfortable” refers to a gas that is evaluated on average as the negative side (unpleasant side) of the intermediate value of 0 in 9 grades odor hedonics for a sensory test of gas. When the gas adsorbent is used to adsorb a malodorous gas, the malodorous gas is easily adsorbed by the gas adsorbent. As a result, the gas adsorbent of the disclosure can remove a malodorous gas.

### <Metal Organic Framework>

The gas adsorbent of the disclosure includes a metal organic framework.

The metal organic framework includes: at least one metal atom selected from the group consisting of Zr, Zn, Al, and Mg; and an organic ligand having at least one group selected from the group consisting of a carboxy group and a carboxylate group.

The metal organic framework of the disclosure is also referred to as porous organic metal complex. The term “porous” refers to a structure having a plurality of pores. The plurality of pores optionally communicates with each other.

The metal atom contained in the metal organic framework may be one kind or two or more kinds.

The metal atom contained in the metal organic framework is preferably at least one selected from the group consisting of Zr and Zn, and more preferably Zr, from the viewpoint of gas adsorptivity:

Among them, the metal organic framework preferably has a metal cluster, more preferably has a zirconium cluster, and particularly preferably has a zirconium oxy cluster from the viewpoint of gas adsorptivity.

The organic ligand used in the metal organic framework is not particularly limited as long as it has at least one group selected from the group consisting of a carboxy group and a carboxylate group and can form the metal organic framework. The organic ligand is preferably a polycarboxylic acid having an ethylene skeleton or a benzene skeleton, or an anion of the polycarboxylic acid. The “polycarboxylic acid” is a compound containing two or more carboxy groups in one molecule. When the organic ligand is a polycarboxylic acid having an ethylene skeleton or a benzene skeleton, or an anion of the polycarboxylic acid, the gas adsorbent of the disclosure is more excellent in adsorptivity.

Examples of the polycarboxylic acid having an ethylene skeleton include, but are not limited to, fumaric acid and maleic acid.

Examples of the polycarboxylic acid having a benzene skeleton include, but are not limited to, phthalic acid, isophthalic acid, terephthalic acid, 2,6-naphthalenedicarboxylic acid, and 4,4′-biphenyldicarboxylic acid.

Examples of the organic ligand having a carboxylate group include an anion of the polycarboxylic acid.

Among them, the organic ligand is preferably a dicarboxylic acid compound or a biscarboxylate ion compound, more preferably a dicarboxylic acid having a carboxy group and a divalent hydrocarbon group or a dianion thereof, still more preferably a dicarboxylic acid having a carboxy group and a divalent aromatic hydrocarbon group or a dianion thereof, and particularly preferably terephthalic acid or a terephthalic acid dianion, from the viewpoint of the formability of the metal organic framework and gas adsorptivity.

The “divalent hydrocarbon group” means a hydrocarbon group obtained by removing two functional groups from an organic ligand having two functional groups capable of being coordinated to a metal ion. The “divalent aromatic hydrocarbon group” means an aromatic hydrocarbon group obtained by removing two functional groups from an organic ligand having two functional groups capable of being coordinated to a metal ion.

From the viewpoint of the formability of the metal organic framework and gas adsorptivity, it is preferable that the metal atom in the metal organic framework is Zr, and the organic ligand is a dicarboxylic acid compound or a biscarboxylate ion compound, and it is particularly preferable that the metal atom in the metal organic framework is Zr, and the organic ligand is terephthalic acid or a terephthalic acid dianion.

The content of the organic ligand in the metal organic framework can be adjusted according to the type and amount of the metal atoms, if appropriate. Particularly, from the viewpoint of gas adsorptivity, the molar ratio between the metal atom and the organic ligand is preferably metal atom:organic ligand=from 1:0.05 to 1:5, more preferably metal atom:organic ligand=from 1:0.1 to 1:3, and particularly preferably metal atom:organic ligand=from 1:0.5 to 1:2. The molar ratio between the metal atom and the organic ligand may be metal atom:organic ligand=from 1:1.0 to 1:1.5.

The content of nitrogen atoms in the gas adsorbent is preferably 5 mass % or less, more preferably less than 5 mass %, still more preferably 2.0 mass % or less, particularly preferably 0.5 mass % or less, and most preferably 0.1 mass % or less, from the viewpoint of suppressing decomposition of a resin and suppressing coloration of a resin. The lower limit value of the nitrogen atom content is (mass % in the gas adsorbent.

When a compound having a nitrogen atom is used as a reactive substrate of the metal organic framework or a solvent (particularly, a solvent), nitrogen atoms are mixed into the metal organic framework and the gas adsorbent.

Examples of the compound having a nitrogen atom used in the synthesis of the metal organic framework include a compound having a nitrogen-containing functional group (for example, an amino group, an amide group, an imide group, or the like). Specific examples of the compound having a nitrogen atom include N,N-dimethylformamide (DMF), N,N-diethylformamide (DEF), N,N-dimethylacetamide (DMAc), ammonia, and triethylamine.

The method for producing the metal organic framework used in the disclosure is not particularly limited, and a known method and a method applying the same can be suitably used. The metal organic framework to be contained may be one kind or two or more kinds.

The content of the metal organic framework in the gas adsorbent is preferably 10 mass % or more, and more preferably 50) mass % or more, with respect to the total amount of the gas adsorbent. The content of the metal organic framework may be 100 mass %. That is, the gas adsorbent may be made only of the metal organic framework. The content of the metal organic framework may be 50 mass % or less, or may be 30 mass % or less.

The maximum pore size of the metal organic framework is preferably from 0.2 nm to 2.0 nm, more preferably from 0.4 nm to 1.5 nm.

The “maximum pore size” means the maximum diameter of pores formed in the metal organic framework. The maximum pore size is measured using a nitrogen adsorption measuring apparatus, and is measured using, for example, a model number “AUTOSORB-1” (manufactured by Anton Paar GmbH).

The metal organic framework is preferably particulate. The primary particle size of the particle is preferably from 0.01 μm to 3.0 μm, more preferably from 0.02 μm to 2.0 μm, and still more preferably from 0.05 μm to 1.5 μm.

The primary particle size is measured by the following method.

First, the metal organic framework is observed with a semi-in-lens scanning electron microscope (SEM) (product name “S-4800”, manufactured by Hitachi High-Technologies Corporation) at an appropriate magnification. The particle is identified based on the obtained SEM image. In a SEM image at a magnification at which a single particle can be observed, the size of the longest part of the particle (hereinafter, also referred to as “longest size”) is measured. The longest size is measured for 100 particles, and the average value of the measured values is defined as the primary particle size.

The BET specific surface area per mass of the metal organic framework is not particularly limited, and may be from 1000 m²/g to 2000 m²/g, from 1000 m²/g to 1600 m²/g, or from 1000 m²/g to 1200 m²/g. The method for measuring the BET specific surface area per mass of the metal organic framework is as described in Example.

The gas adsorbent of the disclosure may contain components other than the metal organic framework.

The other components are not particularly limited. Examples thereof include a known deodorant (for example, an acidic gas deodorant, a basic gas deodorant, a sulfur-based gas deodorant, an aldehyde-based gas deodorant, and a ketone-based gas deodorant), an antibacterial agent, an antifungal agent, an antiviral processing agent, an anti-allergen agent, an antifoaming agent, a coloring agent, an antiseptic, a viscosity modifier, a fragrance, a surfactant, water, a solvent, a preservative, a humectant, a thickener, a pH adjuster, a bleaching agent, a chelating agent, a water-soluble salt, and an oil.

The gas adsorbent of the disclosure is preferably used for adsorbing an acidic gas. In other words, when the gas adsorbent is used for adsorbing a malodorous gas, the malodorous gas is preferably an acidic gas. The “acidic gas” is a gas of a molecule having a free proton and exhibiting volatility: Examples of the acidic gas include a carboxylic acid (for example, formic acid, acetic acid, propionic acid, butyric acid, valeric acid, and isovaleric acid), a hydrogen halide (for example, hydrogen chloride and hydrogen bromide), an inorganic acid (for example, carbonic acid, nitric acid, and sulfuric acid), and an acidic gas (for example, hydrogen sulfide). Among them, the gas adsorbent of an embodiment of the disclosure is more preferably used for adsorbing a carboxylic acid and hydrogen sulfide. The gas adsorbent of an embodiment of the disclosure is particularly preferably used for adsorbing acetic acid gas. That is, the gas adsorbent of the disclosure is preferably an acidic gas adsorbent, and more preferably an acetic acid gas adsorbent.

The adsorption capacity of gas of the gas adsorbent is not particularly limited, but is preferably 40 mL/g or more, more preferably 45 mL/g or more, and still more preferably 50 mL/g or more. The adsorption capacity of gas may be 70 mL/g or less, or may be 61 mL/g or less. In the adsorption capacity; the gas adsorbed by the gas adsorbent may be acetic acid gas. When the adsorption capacity of gas of the gas adsorbent is 40 mL/g or more, the gas adsorbent of the disclosure can further remove malodorous gases.

In the disclosure, the “adsorption capacity” means the maximum amount of a specific gas that can be adsorbed by the gas adsorbent. In other words, the “adsorption capacity” means the adsorption capacity of adsorbing through the adsorption mechanism of both physical adsorption and chemical adsorption.

In the disclosure, the adsorption capacity of gas is measured by the following method.
(1) The gas adsorbent is packed and sealed in a bag made of a vinyl alcohol-based polymer film, and air is put into the bag so that the volume is 3 L.
(2) A specific gas (for example, acetic acid gas) is put into the bag so that the specific gas has a concentration of 500 ppm
(3) The concentration of the specific gas remaining in the bag (hereinafter, also referred to as “residual gas amount”) is measured with a gas detection tube 120 minutes after the completion of the injection of the specific gas.
(4) The adsorption capacity of the specific gas of the gas adsorbent is calculated based on the following Formula (2).

$$Adsorption capacity of specific gas ( mL / g ) = [ \{ 500 ( ppm ) - Measured value of residual gas amount ( ppm ) \} \times 3 , 000 ( mL ) \times 1 / 1 , 000 , 000 ] / Amount of gas adsorbent used for measurement ( g ) \qquad Formula ( 2 )$$

The reduction rate represented by the following Formula (1) is preferably 50% or less.

Reduction rate=100×{(weight average molecular weight of heated product of polyester resin alone)−(weight average molecular weight of heated product of mixture)/(weight average molecular weight of heated product of the polyester resin alone)} Formula (1)

In Formula (1), the heated product of the polyester resin alone represents a product obtained by heating the polyester resin alone at 280° C. for 1 hour.

The heated product of the mixture represents a product obtained by heating a mixture of 80 parts by mass of the polyester resin and 20 parts by mass of the gas adsorbent at 280° C. for 1 hour.

When the reduction rate represented by the following Formula (1) is 50% or less, the gas adsorbent of the disclosure can further suppress coloring and decomposition of a polyester resin when kneaded into the polyester resin.

From the viewpoint of further suppressing coloring and decomposition of a polyester resin, the reduction rate is more preferably 25% or less, and still more preferably 18% or less. The reduction rate may be 10% or more.

### <Application>

The gas adsorbent of the disclosure can be used as a deodorant in various applications. The gas adsorbent of the disclosure is blended in a fiber, a resin, a liquid (for example, water, an organic solvent, or the like), or the like, and can be used as a raw material for producing a deodorant product or the like.

Particularly, as described above, the gas adsorbent of the disclosure can be suitably used as a gas adsorbent to be kneaded in a resin, and can be more suitably used as a gas adsorbent to be kneaded in a polyester resin.

The gas adsorbent of the disclosure can be suitably used as a kneaded yarn, a textile product, or a resin composite (that is, a resin material in which the gas adsorbent is kneaded into a resin).

The gas adsorbent of the disclosure can be particularly suitably used for a kneaded yarn made of a polyester resin, a polyester resin textile product, or a polyester resin composite, because a polyester resin is prevented from coloring and decomposition when mixed and/or contacted with the gas adsorbent.

The gas adsorbent of the disclosure is also suitable for, for example, a processing solution for gas adsorption, a resin composition (that is, a mixture containing the gas adsorbent of the disclosure and a resin other than the resin composite), or the like.

The resin composite or the resin composition according to the disclosure preferably contains the gas adsorbent of the disclosure and a resin, and more preferably contains the gas adsorbent of the disclosure and a polyester resin.

The method of producing the resin composite or the resin composition is not particularly limited. Examples thereof include a method in which the gas adsorbent and the resin are mixed and then molded, and a method in which a pelletized resin containing the gas adsorbent in a high concentration is prepared in advance, and the pelletized resin and another resin are mixed and then molded. Examples of the molding method include injection molding, extrusion molding, inflation molding, and vacuum molding.

The resin constituting the resin composite or the resin composition is not particularly limited. Examples thereof include a polyester resin, a polyurethane resin, a polyolefin resin, a polyamide resin, a polyether resin, an acrylic resin, acrylonitrile-butadiene-styrene (ABS resin), nylon, a polystyrene resin, a polycarbonate resin, and a vinyl chloride resin.

Among them, a polyester resin can be suitably used.

The content of the gas adsorbent in the resin composite or the resin composition is preferably from 0.1 mass % to 50 mass %, more preferably from 0.2 mass % to 35 mass %, and particularly preferably from 0.5 mass % to 25 mass % with respect to the total amount of the resin composite or the resin composition.

The resin composite or the resin composition may contain an additive. Examples of the additive include a pigment, a dye, an antioxidant, a photostabilizer, an antistatic agent, a foaming agent, a shock-resisting agent, a glass fiber, a desiccant, a thickener, a known deodorant (for example, an acidic gas deodorant, a basic gas deodorant, a sulfur-based gas deodorant, an aldehyde-based gas deodorant, and a ketone-based gas deodorant), an antibacterial agent, an antifungal agent, an antiviral processing agent, an anti-allergen agent, an antifoaming agent, a coloring agent, an antiseptic, a viscosity modifier, a fragrance, a surfactant, a preservative, a humectant, a water-soluble salt, and an oil.

The resin composite or the resin composition according to the disclosure is applicable to various products that require deodorizing properties. Examples of the product include a home electric appliance (for example, an air purifier, a refrigerator, an air conditioner, or the like), a general household product (for example, a trash can, draining, wrapping, sponge, or the like), a nursing care product (for example, a portable toilet or the like), a house building material (for example, wall paper, toilet bowl, toilet seat, kitchen counter, ventilator filter, paint, or the like), a vehicle interior, a pet product, and a daily necessity.

The gas adsorbent of the disclosure, having a high gas adsorption property, can be applied to a processing solution (for example, a deodorant processing solution or the like). The processing solution is applied or permeated to a yarn, a textile product, a wood product, a resin product, a metal product, or the like.

The processing solution preferably contains a dispersion medium, a dispersant, and an adhesive in addition to the gas adsorbent.

Examples of the dispersion medium include an organic solvent (for example, alcohol, ketone, ester, hydrocarbon, or the like), water, and the like.

When the dispersion medium is water, examples of the dispersant include a polycarboxylic acid dispersant, a naphthalene sulfonic acid formalin condensing dispersant, polyethylene glycol, an alkyl sulfonic acid dispersant, a quaternary ammonium dispersant, a higher alcohol alkylene oxide dispersant, and a polyphosphoric acid dispersant. When the dispersion medium is an organic solvent, examples of the dispersant include a polycarboxylic acid alkyl ester dispersant, a polyether dispersant, a polyalkylamine dispersant, a polyhydric alcohol ester dispersant, and an alkyl polyamine dispersant.

Examples of the adhesive include a novolac-type or resol-type phenol resin, an alkyd resin, an aminoalkyd resin, an acrylic resin, a vinyl chloride resin, a vinylidene chloride resin, a silicone resin, a fluororesin, an epoxy resin, a urethane resin, a saturated polyester resin, and a melamine resin.

The content of the gas adsorbent in the processing solution is preferably from 0.1 mass % to 50 mass %, more preferably from 0.2 mass % to 30 mass %, and still more preferably from 0.3 mass % to 20 mass % with respect to the total amount of the processing solution.

The gas adsorbent of the disclosure can be suitably used for a kneaded yarn or a textile product.

Suitable examples of the textile product include a textile product obtained by processing the kneaded yarn, and a textile product in which the gas adsorbent is attached on the surface of yarn, cloth, or the like.

These can be suitably used as a deodorant fiber or a deodorant cloth.

The method of producing a kneaded yarn or a textile product using the gas adsorbent of the disclosure is not particularly limited. Examples thereof include a method in which the gas adsorbent of the disclosure is kneaded into a fiber raw material and then spun; and a method in which a deodorant processing solution containing the gas adsorbent of the disclosure is applied to a fiber (for example, spun chemical fiber, natural fiber, or the like) and dried.

The fiber used in the disclosure is not particularly limited. Examples thereof include a chemical fiber (for example, polyester resin, polyurethane resin, nylon, rayon, acrylic resin, vinylon, polypropylene, polyethylene, or the like), a natural fiber (for example, cotton, hemp, silk, wool, or the like), and an inorganic fiber (for example, glass fiber, carbon fiber, alumina fiber, metal fiber, or the like). These fibers may be used singly or in combination of two or more kinds thereof.

Among them, a polyester resin is preferable.

The content of the gas adsorbent in the kneaded yarn is preferably from 0.1 mass % to 5.0 mass %, more preferably from 0.2 mass % to 3.0 mass %, and particularly preferably from 0.5 mass % to 2.0 mass % with respect to the total amount of the kneaded yarn.

Examples of the textile product include underwear, stockings, socks, a mask, a futon, a futon cover, a cushion, a blanket, a carpet, a curtain, a sofa, a car seat, an air filter, an air purifier filter, an air conditioner filter, and nursing care clothes.

The gas adsorbent of the disclosure, having a high malodorous gas adsorption performance, can be suitably applied to a deodorant cloth. The cloth may be a woven fabric, a nonwoven fabric, or a combination thereof.

The method of producing the deodorant cloth is not particularly limited. Examples thereof include a method in which the deodorant fiber is weaved, a method in which a nonwoven fabric is produced by a known method using the deodorant fiber, and a method in which a deodorant processing solution containing the gas adsorbent of the disclosure is applied to cloth and dried.

The content of the gas adsorbent in the deodorant cloth is preferably from 0.1 g to 5.0 g. more preferably from 0.2 g to 4.0 g, and particularly preferably from 0.3 g to 3.0 g per 1 m² of the area of the deodorant cloth.

The gas adsorbent of the disclosure, having a high malodorous gas adsorption performance, can be applied to a deodorant filter medium.

The method of producing the deodorant filter medium is not particularly limited. Examples thereof include a method in which a deodorant processing solution containing the gas adsorbent of the disclosure is applied to a substrate and dried; and a method in which the deodorant filter medium is produced by using the deodorant fiber or the deodorant cloth.

The substrate is not particularly limited as long as it has pores that allow filtration. Examples thereof include a fiber, a ceramic, and a metal.

The content of the gas adsorbent in the deodorant filter medium is preferably from 0.1 g to 40 g, more preferably from 0.5 g to 35 g, and still more preferably from 1.0 g to 30 g per 1 m² of the area of the substrate.

The deodorant filter medium can be applied to various products. Examples of the product include an air filter, an air purifier filter, an air conditioner filter, a drainer, and a water purifier.

### (Metal Organic Framework)

The metal organic framework of the disclosure includes: at least one metal atom selected from the group consisting of Zr, Zn, Al, and Mg; and an organic ligand having at least one group selected from the group consisting of a carboxy group and a carboxy late group. The content of nitrogen atoms is less than 5 mass % with respect to the total mass of the metal organic framework.

Preferred embodiments of the metal organic framework of the disclosure are the same as the preferred embodiments of the metal organic framework in the gas adsorbent of the disclosure, except as described later.

The content of nitrogen atoms in the metal organic framework is less than 5 mass %, and from the viewpoint of suppressing decomposition of a resin and suppressing coloration of a resin, more preferably 2 mass % or less, still more preferably 0.5 mass % or less, and particularly preferably 0.1 mass % or less. The lower limit value of the nitrogen atom content is 0 mass % in the metal organic framework.

In a spectrum obtained by measuring the metal organic framework by powder X-ray diffraction measurement (PXRD), the half-value width of the main peak (peak width at the ½ height of the peak height) is preferably 0.4° or less, more preferably 0.35° or less, and particularly preferably 0.3° or less.

### EXAMPLES

Hereinafter, the disclosure will be specifically described based on Examples. Note that the disclosure is not limited to these Examples. Hereinafter, “parts” and “%” mean “parts by mass” and “mass %”, respectively, unless otherwise specified.

### <Reagent>

The reagents used in the Examples are as follows.
Zirconium oxychloride octahydrate (ZrOCl₂·8H₂O, manufactured by FUJIFILM Wako Pure Chemical Corporation)
Acetic acid (manufactured by FUJIFILM Wako Pure Chemical Corporation)
Sodium carbonate (manufactured by FUJIFILM Wako Pure Chemical Corporation)
Terephthalic acid (manufactured by Tokyo Chemical Industry Co., Ltd.)
Sodium hydroxide (manufactured by FUJIFILM Wako Pure Chemical Corporation)
Ethanol (manufactured by FUJIFILM Wako Pure Chemical Corporation)
ZrCl₄ (manufactured by FUJIFILM Wako Pure Chemical Corporation)
Dimethylformamide (manufactured by FUJIFILM Wako Pure Chemical Corporation)
Concentrated hydrochloric acid (manufactured by FUJIFILM Wako Pure Chemical Corporation)
Methanol (manufactured by FUJIFILM Wako Pure Chemical Corporation)

### Example 1: Synthesis of Metal Organic Framework (UiO-66)

### <Preparation of Metal Cluster Solution>

Into 30 g of pure water. 3.22 g (10 mmol) of ZrOCl₂·8H₂O and 13.1 g of acetic acid were added, and stirred at 50° C. for 24 hours. Thereafter, the solution was added with 1.48 g of sodium carbonate and stirred to set the pH (25° C.) at 5.0 and to prepare a metal cluster solution.

### <Preparation of Organic Ligand Solution>

Into 50 g of pure water, 1.66 g (10 mmol) of terephthalic acid and 0.8 g (20 mmol) of sodium hydroxide were added, and stirred at 80° C. for 30 minutes to prepare an organic ligand solution.

### <Synthesis of Metal Organic Framework>

At room temperature (hereinafter, 25° C.), 12.0 g of the organic ligand solution was added dropwise to 9.0 g of the metal cluster solution under stirring. Thereafter, 10.5 g of ethanol was added, and the mixture was stirred at 40° C. for 1 hour. After solid-liquid separation by centrifugation, the solid was recovered, washed 3 times with 50 mL of water, and then heated at 80° C. overnight to be dried, thereby obtaining the product of Example 1 (metal organic framework UiO-66 ([Zr₆(OH)₄O₄(bdc)₆]), white, particulate). The bdc represents a terephthalate dianion. The molar ratio between the zirconium atom and the organic ligand is zirconium atom:organic ligand=1:1.22.

### Example 2: Synthesis of Metal Organic Framework (UiO-66)

In a polytetrafluoroethylene container, 40 mL of dimethylformamide (DMF), 0.62 g of terephthalic acid, and 0.87 g of ZrCl₄ were added, and dissolved by ultrasonic stirring. Then, 0.375 mL of concentrated hydrochloric acid was added into the polytetrafluoroethylene container, and the polytetrafluoroethylene container was sealed with a stainless steel jacket and allowed to stand in an oven at 120° C. for 24 hours. After 24 hours, the mixture was allowed to cool to room temperature, and then centrifuged to collect a powder. The powder was decanted, with the supernatant discarded, and washed with DMF and methanol. After another centrifugation, the powder was suspended in 80 ml of methanol, and stirred at 25° C. overnight to substitute the solvent with methanol. Filtration was then carried out and the solid was washed three times with methanol. Thereafter, the solid was dried at 80° C. overnight to obtain the metal organic framework (UiO-66, white, particulate) of Example 2.

### Example 3: Synthesis of Metal Organic Framework (UiO-66)

In a polytetrafluoroethylene container, 40 mL of DMF, 0.62 g of terephthalic acid, and 0.87 g of ZrCl₄ were added, and dissolved by ultrasonic stirring. Then, 0.375 ml of concentrated hydrochloric acid was added into the polytetrafluoroethylene container, and the polytetrafluoroethylene container was sealed with a stainless steel jacket and allowed to stand in an oven at 120° C. for 24 hours. After 24 hours, the mixture was allowed to cool to room temperature, and then centrifuged to collect a powder. The powder was decanted, with the supernatant discarded, and washed with DMF and methanol. Thereafter, the solid was dried at 80° C. overnight to obtain the metal organic framework (UiO-66) of Example 3.

### Example 4: Synthesis of Metal Organic Framework (UiO-66)

In a polytetrafluoroethylene container, 40 mL of DMF, 0.62 g of terephthalic acid, and 0.87 g of ZrCl₄ were added, and dissolved by ultrasonic stirring. Then, 0.375 ml of concentrated hydrochloric acid was added into the polytetrafluoroethylene container, and the polytetrafluoroethylene container was sealed with a stainless steel jacket and allowed to stand in an oven at 120° C. for 24 hours. After 24 hours, the mixture was allowed to cool to room temperature, and then centrifuged to collect a powder. The powder was decanted, with the supernatant discarded, and washed with DMF. Thereafter, the solid was dried at 80° C. overnight to obtain the metal organic framework (UiO-66) of Example 4.

### Comparative Example 1: Synthesis of Metal Organic Framework (ZIF-8)

Into a beaker, 35 mL of pure water and 10 g of 2-methylimidazole were added, and stirred at 25° C. for 10 minutes to prepare an aqueous solution of 2-methylimidazole. Next, 6 mL of pure water and 0.9 g of zinc nitrate were mixed and stirred at 25° C. for 10 minutes to prepare an aqueous solution of zinc nitrate. Further, the aqueous solution of 2-methylimidazole and the aqueous solution of zinc nitrate were mixed and stirred at 25° C. for 10 minutes. The obtained reaction liquid was filtered, and the filtered solid was washed with pure water. The washed solid was dried at 80° C. overnight and then pulverized in a mortar to obtain a metal organic framework (ZIF-8).

### <Method for Analyzing Powder X-Ray Crystal Structure Analysis (PXRD) Spectrum>

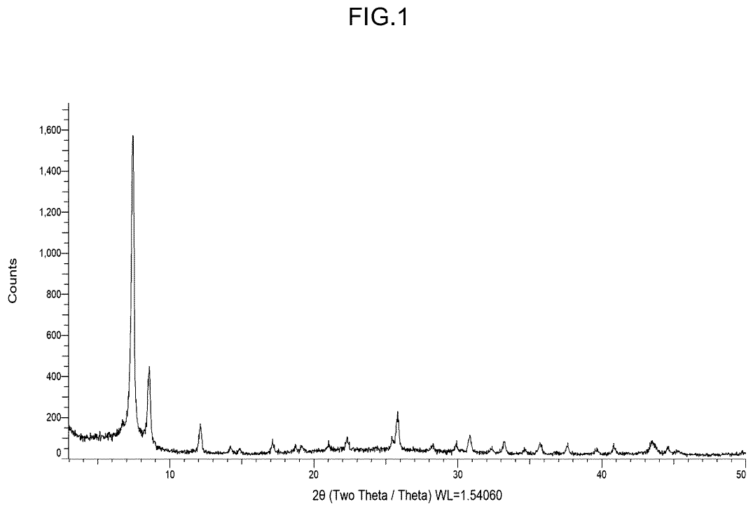

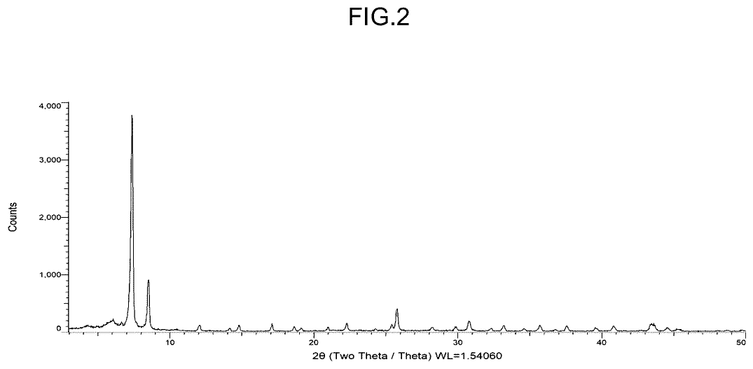

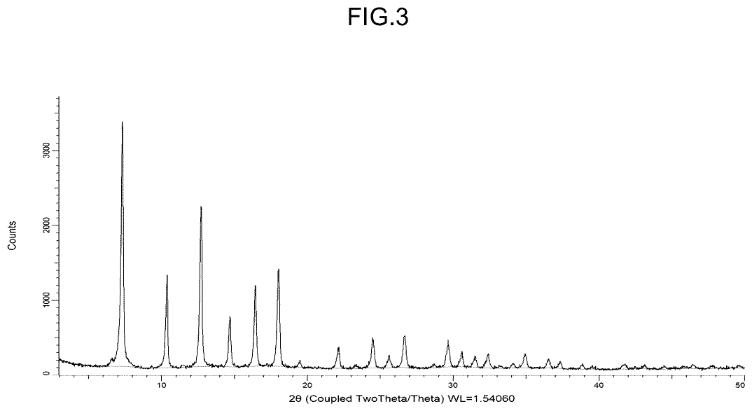

The PXRD spectrum was analyzed using D8ADVANCE manufactured by Bruker Japan K.K. The measurement angle was from 3° to 50°. The results are shown in FIGS. 1 to 3. FIG. 1 is a spectrum of the metal organic framework obtained in Example 1. FIG. 2 is a spectrum of the metal organic framework obtained in Example 2. FIG. 3 is a spectrum of the metal organic framework obtained in Comparative Example 1. In each drawing, the vertical axis represents the diffracted X-ray intensity (Counts), and the horizontal axis represents the diffraction angle (2θ(°)).

### <Method for Measuring Nitrogen Atom Content>

The nitrogen element content (mass %) was quantified by the Dumas method using MICRO CORDER JM11 manufactured by J-Science Lab Co., Ltd. The results are shown in Table 1.

### <Method for Analyzing Specific Surface Area>

About 150 mg of the obtained metal organic framework was collected, vacuum-dried at 120° C. for 9 hours, and then weighed. Using “AUTOSORB-1” manufactured by Anton Paar GmbH, the nitrogen gas adsorption amount at the boiling point of liquid nitrogen (−195.8° C.) was measured at 5 points in the range of a relative pressure of from 0.1 to 0.3 to prepare an adsorption isotherm, and the BET specific surface area (m²/g) per mass was determined.

### <Acetic Acid Gas Adsorption Capacity Evaluation Test>

About 20 mg of the obtained metal organic framework as a sample is packed and sealed in a bag made of a vinyl alcohol-based polymer film, and air is put into the bag so that the volume is 3 L. Thereafter, acetic acid gas was put into the bag so that the concentration of acetic acid gas was 500 ppm. The residual gas concentration (hereinafter, also referred to as “residual gas amount”) in the bag was measured 120 minutes after the completion of the injection of acetic acid gas. The adsorption capacity of acetic acid gas of each sample was determined by the following Formula (3). The results are shown in Table 1.

$$Adsorption capacity of acetic acid gas ( mL / g ) = [ \{ 500 ( ppm ) - Measured value of residual gas amount ( ppm ) \} \times 3 , 000 ( mL ) \times 1 / 1 , 000 , 000 ] / Amount of gas adsorbent used for measurement ( g ) \qquad Formula ( 3 )$$

<Evaluation of Mixing with Polyester Resin>

A mixture was obtained by mixing 0.8 g of a polyester resin (MA2101M manufactured by UNITIKA LTD.) and 0.2 g of the gas adsorbent. The mixture was placed in a magnetic crucible and heated at 280° C. for 1 hour using a muffle furnace (FUW252PB manufactured by ADVANTEC TOYO KAISHA, LTD.). Thus, a heated product of the mixture was obtained. After the mixture was allowed to cool, 0.1 g of the heated product of the mixture was cut out and dissolved in a mixed solvent of chloroform: 1,1,1,3,3,3-hexafluoro-2-propanol=1:1 (volume ratio). The weight average molecular weight Mw of the heated product of the mixture (hereinafter, also referred to as “Mw of the heated product of the mixture”) was measured using GPC (HLC-8120GPC manufactured by Tosoh Corporation, column: TSKgel SuperHZM-M 6.0 mmI.D.×15 cm manufactured by Tosoh Corporation).

The Mw of the heated 8 product of the polyester resin alone was measured in the same manner as in the method for measuring the Mw of the heated product of the mixture except that the mixture was changed to the polyester resin alone.

The reduction rate (%) was calculated by the following Formula (4).

$$Reduction rate of Mw ( \% ) = 100 \times \{ ( Mw of heated product of polyester resin alone ) - ( Mw of heated product of mixture ) / ( Mw of heated product of polyester resin alone ) \} \qquad Formula ( 4 )$$

TABLE 1

| | Nitrogen | BET | Acetic acid | Reduction |
|---|---|---|---|---|
| | atom | specific | gas adsorption | rate of Mw of |
| | content | surface area | capacity | polyester |
| | (mass %) | (m²/g) | (mL/g) | resin (%) |
| Example 1 | 0.0 | 1,155 | 60 | 15 |
| Example 2 | 0.3 | 1,334 | 62 | 20 |
| Example 3 | 1.0 | 1,264 | 65 | 28 |
| Example 4 | 2.5 | 1,917 | 58 | 61 |
| Comparative | 26.0 | 1,294 | 72 | 81 |
| Example 1 | | | | |

As shown in Table 1, the gas adsorbent of Examples 1 to 4 had a smaller reduction rate of the Mw of the polyester resin than that of Comparative Example 1.

Therefore, it can be said that the gas adsorbent of Examples is suitable for use in kneading into a polyester resin or the like.

The disclosures of Japanese Patent Application No. 2022-212322 filed on Dec. 28, 2022 is incorporated herein by reference in their entirety.

All documents, patent applications, and technical standards described in this specification are incorporated herein by reference to the same extent as if each document, patent application, and technical standard were specifically and individually indicated to be incorporated by reference.

1. A metal organic framework, comprising:
at least one metal atom selected from the group consisting of Zr, Zn, Al, and Mg; and
an organic ligand having at least one group selected from the group consisting of a carboxy group and a carboxylate group,
wherein a content of nitrogen atoms is less than 5 mass % with respect to a total mass of the metal organic framework.

2. A gas adsorbent, comprising:
a metal organic framework including:
at least one metal atom selected from the group consisting of Zr, Zn, Al, and Mg; and
an organic ligand having at least one group selected from the group consisting of a carboxy group and a carboxylate group.

3. The gas adsorbent according to claim 2, wherein a content of nitrogen atoms is less than 5 mass % with respect to a total mass of the gas adsorbent.

4. The gas adsorbent according to claim 2, wherein an adsorption capacity of acetic acid gas is 40 mL/g or more.

5. The gas adsorbent according to claim 2, wherein the metal atom in the metal organic framework is Zr, and the organic ligand is a polycarboxylic acid or an anion of the polycarboxylic acid.

6. The gas adsorbent according to claim 2, which is used for adsorbing a malodorous gas.

7. The gas adsorbent according to claim 6, wherein the malodorous gas is an acidic gas.

8. The gas adsorbent according to claim 2, wherein the organic ligand is a polycarboxylic acid having a benzene skeleton or an anion of the polycarboxylic acid.

9. The gas adsorbent according to claim 2, wherein a reduction rate represented by the following Formula (1) is 50% or less:
$$Reduction rate = 100 \times \{ ( weight average molecular weight of heated product of polyester resin alone ) - ( weight average molecular weight of heated product of mixture ) / ( weight average molecular weight of heated product of the polyester resin alone ) \} \qquad Formula ( 1 )$$
wherein, in Formula (1), the heated product of the polyester resin alone represents a product obtained by heating the polyester resin alone at 280° C. for 1 hour, and
the heated product of the mixture represents a product obtained by heating a mixture of 80 parts by mass of the polyester resin and 20 parts by mass of the gas adsorbent at 280° C. for 1 hour.

10. A kneaded yarn, comprising the gas adsorbent according to claim 2.

11. A textile product, comprising the gas adsorbent according to claim 2.

12. A resin composite, comprising the gas adsorbent according to claim 2.
